(19) United States
(12) Patent Application Publication
(10) Pub. No.: US 2023/0398033 A1
(43) Pub. Date: Dec. 14, 2023

(54) MASSAGE DEVICE

(71) Applicant: AISIN CORPORATION, Kariya (JP)

(72) Inventors: Minori MURAI, Kariya-shi (JP); Takashi OGISO, Kariya-shi (JP); Noriko FUJII, Kariya-shi (JP); Tomoko KANBARA, Kariya-shi (JP)

(73) Assignee: AISIN CORPORATION, Kariya (JP)

(21) Appl. No.: 18/194,751

(22) Filed: Apr. 3, 2023

(30) Foreign Application Priority Data
Jun. 9, 2022 (JP) 2022-093662

(51) Int. Cl. A61H 9/00

(52) U.S. Cl. CPC A61H 9/0078; A61H 2201/0149; A61H 2201/1654

(57) ABSTRACT

A massage device includes a base sheet with a sheet shape and an air bag supported by the base sheet. When one surface of the base sheet is a front surface and a surface opposite to the front surface is a back surface, the air bag includes a bag that is located on a side of the front surface of the base sheet, and that is inflated with air intake and deflated with air exhaust, and a sandwiching portion that is located on a side of the back surface of the base sheet and sandwiches the base sheet between the sandwiching portion and the bag in a thickness direction.

### CROSS REFERENCE TO RELATED APPLICATIONS

This application is based on and claims priority under 35 U.S.C. § 119 to Japanese Patent Application No. 2022-093662, filed on Jun. 9, 2022, the entire content of which is incorporated herein by reference.

### TECHNICAL FIELD

The present disclosure relates to a massage device.

### BACKGROUND DISCUSSION

A known massage device that is detachable from a seat of a vehicle is disclosed in JP 2004-121279 A. The massage device includes an air bag that is inflated or deflated with air supply and exhaust, a sheet-like member that supports the air bag, and an air supply and exhaust device that supplies and exhausts air to and from the air bag.

The massage device has been desired to improve work efficiency when the air bag is supported by the sheet-like member.

A need thus exists for a massage device which is not susceptible to the drawback mentioned above.

### SUMMARY

A massage device includes a base sheet with a sheet shape, and an air bag supported by the base sheet, wherein when one surface of the base sheet is a front surface and a surface opposite to the front surface is a back surface, the air bag includes a bag that is located on a side of the front surface of the base sheet, and that is inflated with air intake and deflated with air exhaust, and a sandwiching portion that is located on a side of the back surface of the base sheet and sandwiches the base sheet between the sandwiching portion and the bag in a thickness direction.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view of a massage device mounted on a chair;

FIG. 2 is a plan view of a base sheet that supports an air bag and a connection tube;

FIG. 3 is a plan view of the base sheet;

FIG. 4 is a cross-sectional view taken along line IV-IV in FIG. 2;

FIG. 5 is a partial plan view of a massage device according to a first modification;

FIG. 6 is a cross-sectional view taken along line VI-VI in FIG. 5;

FIG. 7 is a partial plan view of a massage device according to a second modification; and

FIG. 8 is a cross-sectional view taken along line VIII-VIII in FIG. 7.

### DETAILED DESCRIPTION

Hereinafter, an embodiment of a massage device will be described. The massage device is detachable from a chair such as a vehicle seat. In the following description, the massage device will be described using a direction in a case where the massage device is mounted on a chair. In the drawings, for simplification of illustration, hatching indicating a cross section of a metal material is used for a cross section of a member that is not a metal material.

<Configuration of Present Embodiment>

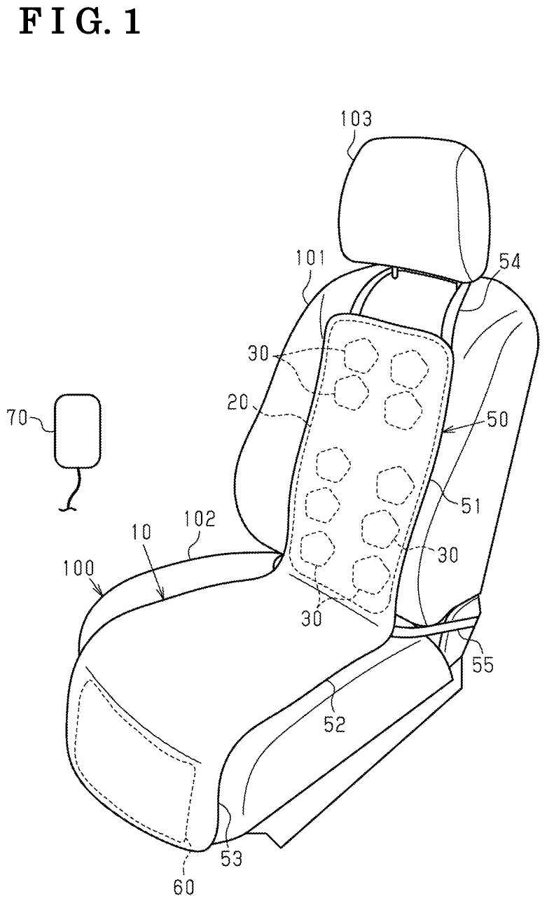

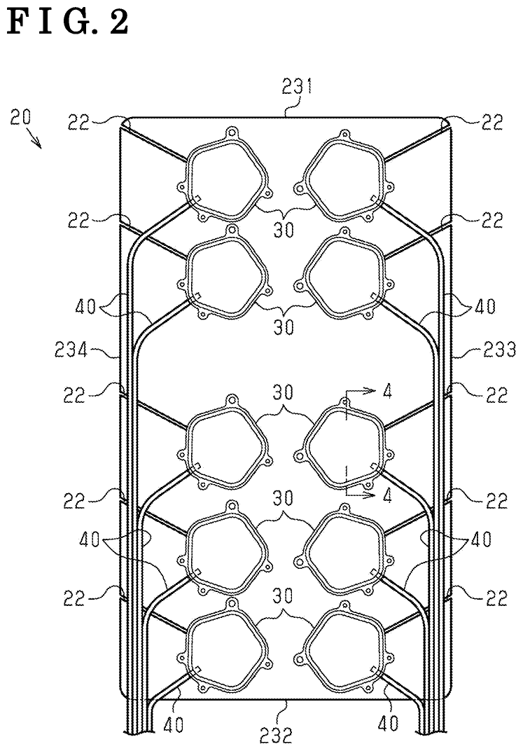

As illustrated in FIGS. 1 and 2, a massage device 10 includes a base sheet 20, a plurality of air bags 30, a plurality of connection tubes 40, a cover 50, a drive unit 60, and a remote controller 70.

<Base Sheet 20>

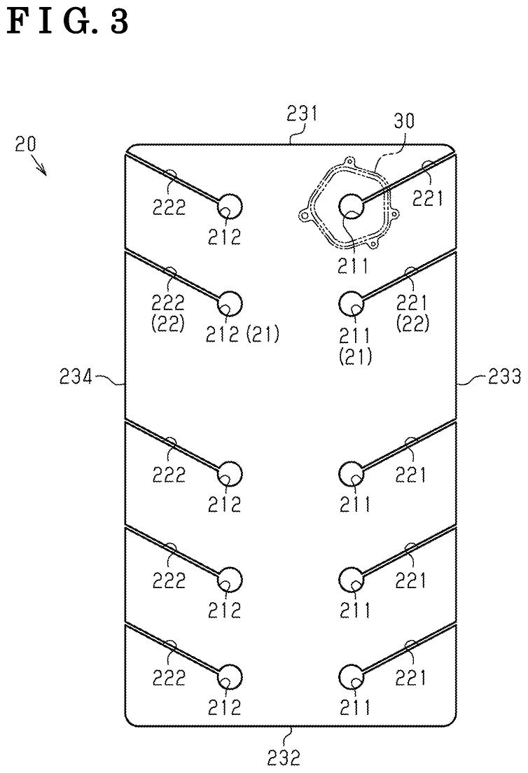

As illustrated in FIGS. 2 and 3, the base sheet 20 has a rectangular shape with a width direction as a short direction and a height direction as a longitudinal direction. The base sheet 20 is a cloth such as a woven fabric or a nonwoven fabric, and has a sheet shape. The fibers constituting the base sheet 20 may be plant fibers, animal fibers, or chemical fibers. The thickness of the base sheet 20 depends on the elastic modulus of the base sheet 20, and is preferably, for example, about 1 mm to 1 cm. In this respect, the base sheet 20 can be folded or rolled. As illustrated in FIG. 1, the base sheet 20 is a portion along a backrest 101 of a chair 100 when the massage device 10 is mounted on the chair 100. In other words, the base sheet 20 is a portion along the back of a user when the user uses the massage device 10.

As illustrated in FIG. 3, the base sheet 20 includes a plurality of support holes 21 (211, 212) and a plurality of slits 22 (221, 222). In addition, the base sheet 20 has an upper end portion 231 and a lower end portion 232 extending in the width direction, and a first side end portion 233 and a second side end portion 234 extending in the height direction.

The plurality of support holes 21 penetrate the base sheet 20 in a thickness direction. The support hole 21 is a round hole in plan view in the thickness direction. The support hole 21 may have another shape such as a square hole. The plurality of support holes 21 are arranged in the width direction and the height direction. In the present embodiment, two support holes 21 are arranged in the width direction, and five support holes 21 are arranged in the height direction.

Each of the plurality of slits 221 extends from the first side end portion 233 toward each of the plurality of support holes 211, and each of the plurality of slits 222 extend from the second side end portion 234 toward each of the plurality of support holes 212. The extending direction of the plurality of slits 22 is inclined with respect to the width direction. Specifically, the plurality of slits 221 extend upward from the plurality of support holes 211 toward the first side end portion 233. Furthermore, the plurality of slits 222 extend upward from the plurality of support holes 212 toward the second side end portion 234. The width of the slit 22 is smaller than the inner diameter of the support hole 21.

The plurality of support holes 21 and the plurality of slits 22 may be formed by cutting using a cutting machine, or may be formed by punching.

<Air Bag 30>

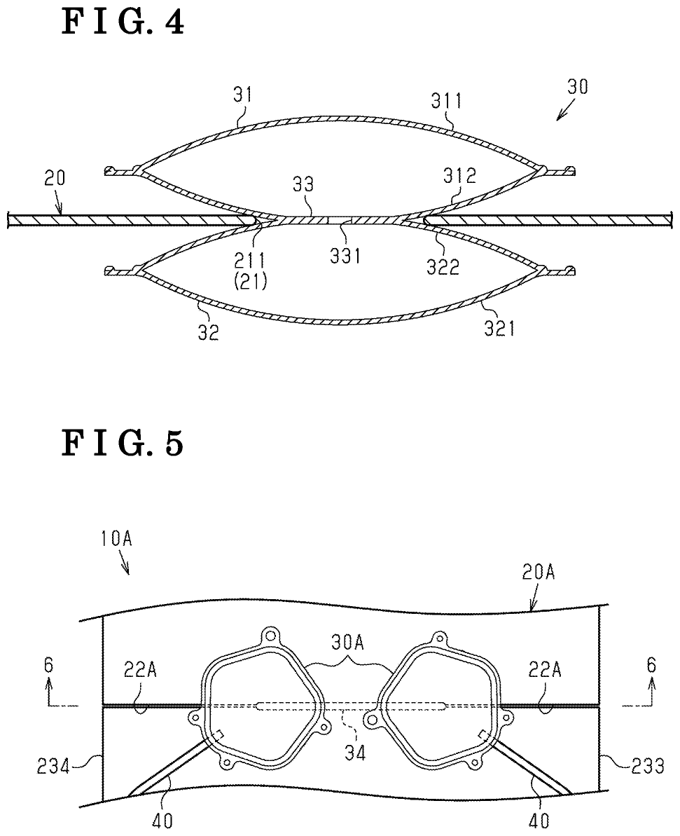

As illustrated in FIG. 4, the air bag 30 includes a first bag 31, a second bag 32, and a joint portion 33. FIG. 4 illustrates a state where the first bag 31 and the second bag 32 are slightly inflated for easy understanding.

The first bag 31 is formed by welding two films 311 and 312. Similarly, the second bag 32 is formed by welding two films 321 and 322. The material of the films 311, 312, 321, and 322 is preferably a resin material with moderate elasticity. In plan view in the thickness direction, the films 311, 312, 321, and 322 has a pentagonal shape. In plan view in the thickness direction, the films 311, 312, 321, and 322 may have another polygonal shape or may have a circular shape. In addition, the first bag 31 and the second bag 32 are equal in size. The first bag 31 may be formed to be larger than the second bag 32, or the first bag 31 may be formed to be smaller than the second bag 32. The first bag 31 and the second bag 32 are inflated with air intake. On the other hand, the first bag 31 and the second bag 32 are deflated with air exhaust.

The joint portion 33 is a portion in which the film 312 constituting the first bag 31 and the film 322 constituting the second bag 32 are joined. Specifically, the joint portion 33 is a portion formed by welding the film 312 and the film 322. The joint portion 33 has a disk shape. The joint portion 33 has a communication hole 331 through which the first bag 31 and the second bag 32 communicate with each other. As a result, the first bag 31 and the second bag 32 are similarly inflated and deflated.

As illustrated in FIGS. 2 and 3, the plurality of air bags 30 are supported by the base sheet Specifically, the plurality of air bags 30 are individually inserted into the plurality of support holes 21 of the base sheet 20. As a result, the plurality of air bags 30 are arranged in the width direction and the height direction of the base sheet 20. As illustrated in FIG. 4, under a situation in which the air bag 30 is supported by the base sheet 20, the first bag 31 of the air bag 30 is located on the front surface side of the base sheet 20, and the second bag 32 of the air bag 30 is located on the back surface side of the base sheet 20. That is, the base sheet 20 is sandwiched between the first bag 31 and the second bag 32 in the thickness direction. Here, the front surface of the base sheet 20 is one surface intersecting with the thickness direction of the base sheet 20, and the back surface of the base sheet 20 is the other surface opposite to the front surface and intersecting with the thickness direction of the base sheet 20. In this respect, the first bag 31 corresponds to “bag”, and the second bag 32 corresponds to “sandwiching portion”.

Under a situation in which the air bag 30 is supported by the base sheet 20, the joint portion 33 of the air bag 30 is located inside the support hole 21 of the base sheet 20. That is, it can be said that the joint portion 33 of the air bag 30 is smaller than the support hole 21 of the base sheet in plan view in the thickness direction. On the other hand, in plan view in the thickness direction, the size of the first bag 31 and the second bag 32 are larger than the size of the support hole 21 of the base sheet 20. That is, the first bag 31 and the second bag 32 have a size that cannot allow the first bag and the second bag to pass through the support hole 21 in the thickness direction.

<Connection Tube 40>

As illustrated in FIG. 2, the number of the plurality of connection tubes 40 is equal to the number of the air bags 30. The connection tube 40 is made of an elastomer such as rubber or resin. The connection tube 40 preferably has moderate elasticity. The first ends of the plurality of connection tubes 40 are individually connected to the plurality of air bags 30. On the other hand, the second ends of the plurality of connection tubes 40 are connected to the drive unit 60. The plurality of connection tubes 40 are supported by the base sheet 20 along the first side end portion 233 and the second side end portion 234 of the base sheet 20. The plurality of connection tubes 40 may be supported by the base sheet 20 by clips or the like, or may be supported by the base sheet by being inserted into holes provided in the base sheet 20.

<Cover 50>

As illustrated in FIG. 1, the cover 50 includes a first housing portion 51, a second housing portion 52, a third housing portion 53, a first belt 54, and a second belt 55.

The first housing portion 51, the second housing portion 52, and the third housing portion 53 have a bag shape. Under a situation in which the massage device 10 is mounted on the chair 100, the first housing portion 51 is a portion disposed along the backrest 101 of the chair 100, and the second housing portion 52 is a portion disposed along the seat surface of a seat portion 102 of the chair 100. Under the same situation, the third housing portion 53 is a portion extending downward from the front end of the seat surface of the seat portion 102 of the chair 100.

The first housing portion 51 houses the base sheet 20 that supports the plurality of air bags 30 and the plurality of connection tubes 40. The second housing portion 52 houses the plurality of connection tubes 40 extending from the first housing portion 51. The second housing portion 52 may house a configuration equivalent to the base sheet 20 that supports the plurality of air bags 30 and the plurality of connection tubes 40. As a result, the massage device 10 can massage the buttocks and the legs of the user seated on the chair 100. The third housing portion 53 houses the drive unit 60. It is preferable that the cover 50 has a fastener so that housed objects can be easily taken in and out of the first housing portion 51, the second housing portion 52, and the third housing portion 53.

The first belt 54 extends upward from the first housing portion 51. The first belt 54 has a loop shape. The first belt 54 is hooked on the headrest 103 to dispose the first housing portion 51 along the backrest 101. The second belt 55 extends laterally from the second housing portion 52. Similarly to the first belt 54, the second belt 55 has a loop shape. The second belt 55 tightens the boundary portion between the first housing portion 51 and the second housing portion 52 to the backrest 101 of the chair 100, thereby preventing the first housing portion 51 and the second housing portion 52 from being displaced from the chair 100. The circumferential length of the first belt 54 and the second belt 55 is preferably adjustable. The first belt 54 and the second belt 55 may be stretchable rubber belts.

<Other Configurations>

The drive unit 60 supplies air to the plurality of air bags 30 and discharges air from the plurality of air bags 30. The drive unit 60 includes, for example, a pump that delivers air, a valve unit that switches a connection destination of a specific air bag 30 among the plurality of air bags 30 to a pump or the atmosphere, and a control device that controls the pump and the valve unit. The drive unit 60 is connected to a power supply source such as a mobile battery or a battery of a vehicle. The remote controller 70 is operated by the user to transmit a signal based on the operation content to the drive unit 60. For example, it is preferable that the remote controller 70 has a power button of the massage device 10 and a button for selecting massage intensity.

<Operation of Present Embodiment>

Hereinafter, the method of assembling the massage device 10 will be described as an operation of the present embodiment. In a case where the assembly of the massage device 10 starts, it is assumed that all the components of the massage device 10 are present.

The method of assembling the massage device 10 includes a supporting step, a connecting step, and a housing step.

The supporting step is a step of causing the base sheet 20 to support the plurality of air bags 30. In the supporting step, the air bag 30 is inserted into the base sheet 20 through the slit 22. At this time, the joint portion 33 of the air bag 30 is moved along the slit 22 until reaching the support hole 21 of the base sheet 20. In a case where the joint portion 33 of the air bag 30 is moved along the slit 22, the width of the slit 22 is temporarily made larger than the width illustrated in FIG. 3 by displacing the base sheet 20 in the thickness direction.

When the joint portion 33 of the air bag 30 reaches the support hole 21 of the base sheet the first bag 31 of the air bag 30 is disposed on the front surface side of the base sheet 20 and the second bag 32 of the air bag 30 is disposed on the back surface side of the base sheet 20 as illustrated in FIG. 4. That is, the base sheet 20 is sandwiched between the first bag 31 and the second bag 32 in the thickness direction. In this way, the air bag 30 is supported by the base sheet 20, The remaining air bags 30 are similarly supported by the base sheet 20.

The connecting step is a step of individually connecting the plurality of connection tubes to the plurality of air bags 30. In the connecting step, the plurality of connection tubes 40 are supported by the base sheet 20.

The housing step is a step of housing the base sheet 20 supporting the plurality of air bags and the plurality of connection tubes 40 in the first housing portion 51 of the cover 50. The housing step is also a step of housing the drive unit 60 in the third housing portion 53 of the cover After the base sheet 20 and the drive unit 60 are housed in the cover 50, the base ends of the plurality of connection tubes 40 extending from the base sheet 20 are connected to the drive unit 60 in the cover 50.

In this way, the assembly of the massage device 10 is completed. After the base sheet is housed in the cover 50, the plurality of air bags 30 come into contact with the back surface of the cover 50. Therefore, the state where the plurality of air bags 30 are supported by the support holes 21 of the base sheet 20 is easily maintained.

<Effects of Present Embodiment>

(1) A massage device including a base sheet with a sheet shape, and an air bag supported by the base sheet, wherein when one surface of the base sheet is a front surface and a surface opposite to the front surface is a back surface, the air bag includes a bag that is located on a side of the front surface of the base sheet, and that is inflated with air intake and deflated with air exhaust, and a sandwiching portion that is located on a side of the back surface of the base sheet and sandwiches the base sheet between the sandwiching portion and the bag in a thickness direction.

According to the above configuration, in the massage device, the air bag is supported by the base sheet by sandwiching the base sheet between the bag of the air bag and the sandwiching portion. Therefore, the work efficiency is improved when the air bag is supported by the base sheet.

In other words, in the massage device 10, the air bag 30 is supported by the base sheet by sandwiching the base sheet 20 between the first bag 31 and the second bag 32 of the air bag That is, in the massage device 10, the air bag 30 can be easily supported by the base sheet 20 in that the air bag 30 does not need to be sewn to the base sheet 20 or the air bag 30 does not need to be adhered to the base sheet 20. As a result, the massage device 10 can improve the work efficiency when the air bag 30 is supported by the base sheet 20.

(2) In the massage device, the base sheet includes a slit extending from an end of the base sheet.

According to the above configuration, the air bag can be inserted into the base sheet through the slit of the base sheet. Therefore, the degree of freedom of the arrangement of the air bags on the base sheet is increased.

In other words, the base sheet 20 has the slit 22 extending from the end of the base sheet 20. As a result, the air bag 30 can be inserted into the base sheet 20 through the slit 22 of the base sheet 20. Therefore, in the massage device 10, the air bag 30 is easily disposed at any position in the base sheet 20. For example, in the massage device 10, the air bag 30 can be easily disposed not only at a position near the side end portions 233 and 234 of the base sheet 20 but also at a position near the central portion in the width direction of the base sheet 20.

(3) In the massage device, the base sheet includes a support hole penetrating the base sheet in the thickness direction, the air bag includes a joint portion that joins the bag and the sandwiching portion, the slit extends from the end of the base sheet to the support hole, and in plan view in the thickness direction, the joint portion is smaller than the support hole, and the bag and the sandwiching portion are larger than the support hole.

According to the above configuration, the joint portion of the air bag can be disposed inside the support hole by inserting the air bag into the base sheet through the slit of the base sheet. Here, in plan view in the thickness direction, the bag and the sandwiching portion of the air bag are larger than the support hole of the base sheet. Therefore, the massage device can prevent the air bag from falling off the base sheet even when a load in the thickness direction acts on the air bag.

In other words, the joint portion 33 of the air bag 30 can be disposed inside the support hole 21 by inserting the air bag 30 into the base sheet 20 through the slit 22 of the base sheet 20. Here, in plan view in the thickness direction, the first bag 31 and the second bag 32 of the air bag are larger than the support hole 21 of the base sheet 20. Therefore, the massage device 10 can prevent the air bag 30 from falling off the base sheet 20 even when a load in the thickness direction acts on the air bag 30.

(4) In the massage device, a width of the slit is smaller than an inner diameter of the support hole.

According to the above configuration, the massage device can prevent the air bag from falling off through the slit from the support hole of the base sheet.

In other words, in the base sheet 20, the width of the slit 22 is smaller than the inner diameter of the support hole 21. Therefore, the massage device 10 can prevent the air bag 30 from falling off through the slit 22 from the support hole 21 of the base sheet 20.

(5) In the massage device, when the bag is a first bag, the sandwiching portion is a second bag that is inflated with air intake and deflated with air exhaust.

According to the above configuration, in the massage device, the air bag is supported by the base sheet by sandwiching the base sheet between two bags of the air bag. Therefore, the massage device does not need to have a configuration only for sandwiching the base sheet in the air bag.

In other words, in the massage device 10, the air bag 30 is supported by the base sheet by sandwiching the base sheet 20 between the two bags 31 and 32 of the air bag 30. Therefore, the massage device 10 does not need to have a configuration only for sandwiching the base sheet in the air bag 30 in the thickness direction.

According to the above configuration, the air bag 30 includes the two bags 31 and 32, that is, the first bag 31 and the second bag 32. As a result, in the massage device 10, the two bags 31, 32 can be arranged in the thickness direction of the base sheet 20. Therefore, the massage device can increase the amount of displacement of the air bag 30 in the thickness direction when the two bags 31 and 32 are inflated while suppressing the increase in size of the air bag 30. That is, the massage device 10 can enhance a massage effect for the user.

(6) In the massage device, the base sheet includes a support hole penetrating the base sheet in the thickness direction, the air bag includes a joint portion that joins the bag and the sandwiching portion, and in plan view in the thickness direction, the joint portion is smaller than the support hole, and the bag and the sandwiching portion are larger than the support hole.

According to the above configuration, the massage device can cause the base sheet to support the air bag by passing the joint portion of the air bag through the support hole of the base sheet. Here, in plan view in the thickness direction, the bag and the sandwiching portion of the air bag are larger than the support hole of the base sheet. Therefore, the massage device can prevent the air bag from falling off the base sheet even when a load in the thickness direction acts on the air bag.

(7) Under a situation in which the massage device 10 is mounted on the chair 100, the slit 22 is directed upward from the support hole 21 toward the side end portions 233 and 234 of the base sheet 20. Therefore, under the same situation, the air bag 30 is less likely to move in the direction of falling off from the support hole 21 of the base sheet 20 even if its own weight acts.

The present embodiment can be modified and implemented as follows. The present embodiment and the following modifications can be implemented in combination with each other within a technically consistent range.

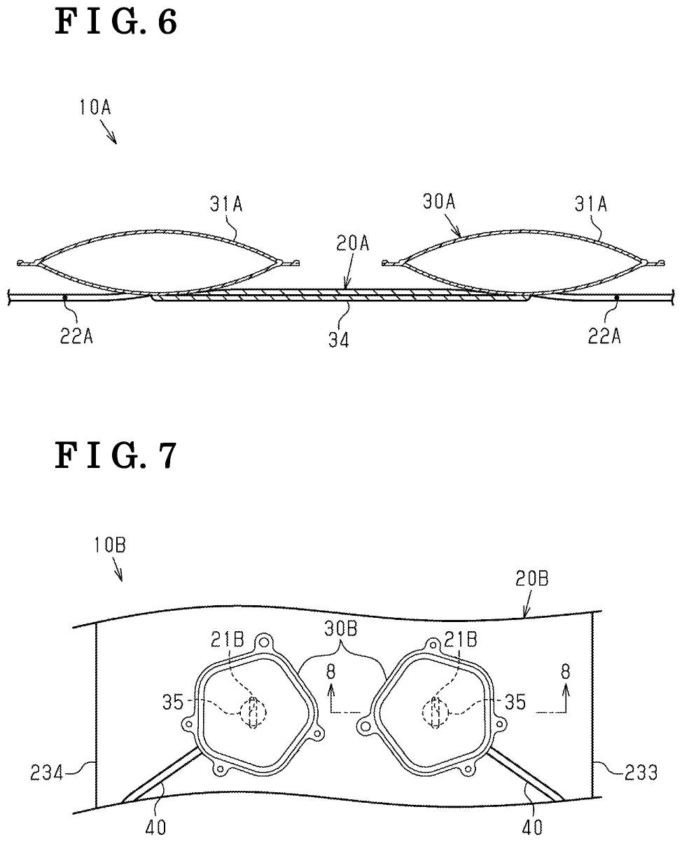

As illustrated in FIGS. 5 and 6, a massage device 10A according to a first modification includes a base sheet 20A, an air bag 30A, and the connection tube 40. The base sheet 20A has a slit 22A extending in the width direction. The slit 22A extends from the first side end portion 233 and the second side end portion 234 of the base sheet 20A toward the center in the width direction of the base sheet. Unlike the above embodiment, the base sheet 20A does not have the support hole 21. The air bag 30A includes two bags 31A and a coupling member 34 that connects the two bags 31A. The two bags 31A have a configuration equivalent to that of the first bag 31 in the above embodiment. The coupling member 34 has a rod shape. The coupling member 34 couples the central portions of the two bags 31A. In the following description, in the coupling member 34, a portion connected to one bag 31A is referred to as a first end portion, and a portion connected to the other bag 31A is referred to as a second end portion.

In a case where the air bag 30A is supported by the base sheet 20A, the first end portion of the coupling member 34 of the air bag 30A is passed through one slit 22A of the base sheet 20A, and the second end portion of the coupling member 34 of the air bag 30A is passed through the other slit 22A of the base sheet 20A. Then, as illustrated in FIG. 6, in the width direction, a portion between the two slits 22A in the base sheet 20A is located between the first end portion and the second end portion of the coupling member 34. Furthermore, the two bags 31A are located on the front surface side of the base sheet 20A, and the coupling member 34 is located on the back surface side of the base sheet 20A. That is, the base sheet 20A is sandwiched between the two bags 31A and the coupling member 34 in the thickness direction. In this way, the air bag 30A is supported by the base sheet 20A.

According to the first modification, it is possible to obtain effects equivalent to the effects (1) and (2) of the above embodiment. In the first modification, the coupling member 34 corresponds to “sandwiching portion”.

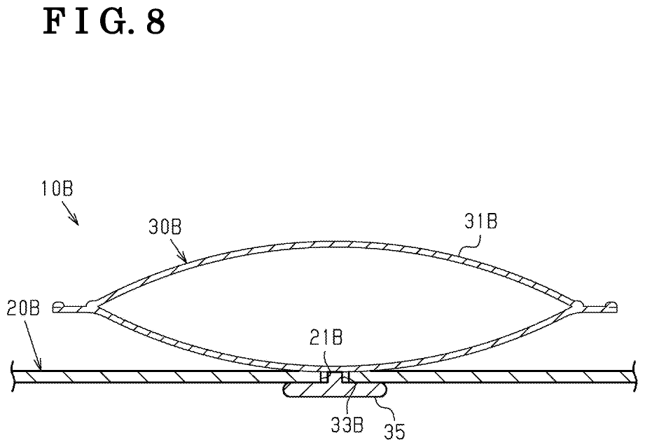

As illustrated in FIGS. 7 and 8, a massage device 10B according to a second modification includes a base sheet 20B and a plurality of air bags 30B. The base sheet 20B has a plurality of support holes 21B penetrating the base sheet in the thickness direction. The support hole 21B has an oval shape in plan view in the thickness direction. The base sheet 20B does not have the slit 22 connected to the support hole 21B. The air bag 30B includes a bag 31B with the equivalent configuration to the first bag 31, a locking piece 35 with a disk shape, and a joint portion 33B that joins the bag 31B and the locking piece 35. The locking piece 35 preferably has a size and a shape that do not fit in the support hole 21B in plan view in the thickness direction. Unlike the locking piece the joint portion 33B preferably has a size and a shape that fit in the support hole 21B in plan view in the thickness direction.

In a case where the air bag 30B is supported by the base sheet 20B, the locking piece 35 of the air bag 30B is passed through the support hole 21B of the base sheet 20B. Then, the bag 31B is located on the front surface side of the base sheet 20B, and the locking piece 35 is located on the back surface side of the base sheet 20B. That is, the base sheet 20B is sandwiched between the bag 31B and the locking piece 35 in the thickness direction. In this way, the air bag 30B is supported by the base sheet 20B.

According to the second modification, it is possible to obtain effects equivalent to the effects (1) and (2) of the above embodiment. In plan view in the thickness direction, the bag 31B and the locking piece 35 of the air bag 30B are larger than the support hole 21B of the base sheet Therefore, the massage device 10B can prevent the air bag 30B from falling off the base sheet even when a load in the thickness direction acts on the air bag 30B. In the second modification, the locking piece 35 corresponds to “sandwiching portion”.

The air bag 30 may include the first bag 31 and the sandwiching portion that sandwiches the base sheet 20 between the sandwiching portion and the first bag 31. The sandwiching portion preferably forms a clip shape together with the first bag 31. In this case, in the air bag 30, the end portion of the base sheet 20 can be sandwiched between the first bag 31 and the sandwiching portion. That is, the air bag 30 can be supported by the base sheet 20 without providing the support hole 21 and the slit 22 in the base sheet 20.

It is preferable that the shape of the massage device 10 is appropriately changed depending on the shape of the chair 100 on which the massage device 10 is mounted. For example, the shape of the base sheet 20 and the shape of the cover 50 are preferably changed, and the number of the air bags 30, the arrangement of the air bags 30, and the like are preferably changed.

The base sheet 20 that supports the plurality of air bags 30 and the plurality of connection tubes 40 may be incorporated in the seat back and the seat cushion of the vehicle seat. In this case, the massage device 10 may be undetachable from the vehicle seat.

In the base sheet 20, the extending direction of the slit 22 can be changed as appropriate. For example, the slit 22 may be bent or curved between the end portion of the base sheet 20 and the support hole 21. As a result, the air bag 30 is less likely to fall off from the support hole 21.

The massage device 10 may be a massage device that massages parts other than the back of the user. For example, the massage device 10 may be disposed on the seat portion 102 of the chair 100 and massage the buttocks and the legs of the user. Furthermore, the massage device 10 may be arranged on a bed and massages the entire body of the user.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A massage device comprising:
a base sheet with a sheet shape; and
an air bag supported by the base sheet, wherein
when one surface of the base sheet is a front surface and a surface opposite to the front surface is a back surface,
the air bag includes a bag that is located on a side of the front surface of the base sheet, and that is inflated with air intake and deflated with air exhaust, and a sandwiching portion that is located on a side of the back surface of the base sheet and sandwiches the base sheet between the sandwiching portion and the bag in a thickness direction.

2. The massage device according to claim 1, wherein the base sheet includes a slit extending from an end of the base sheet.

3. The massage device according to claim 2, wherein
the base sheet includes a support hole penetrating the base sheet in the thickness direction,
the air bag includes a joint portion that joins the bag and the sandwiching portion,
the slit extends from the end of the base sheet to the support hole, and
in plan view in the thickness direction, the joint portion is smaller than the support hole, and the bag and the sandwiching portion are larger than the support hole.

4. The massage device according to claim 3, wherein a width of the slit is smaller than an inner diameter of the support hole.

5. The massage device according to claim 1, wherein
when the bag is a first bag,
the sandwiching portion is a second bag that is inflated with air intake and deflated with air exhaust.

6. The massage device according to claim 2, wherein
when the bag is a first bag,
the sandwiching portion is a second bag that is inflated with air intake and deflated with air exhaust.

7. The massage device according to claim 3, wherein
when the bag is a first bag,
the sandwiching portion is a second bag that is inflated with air intake and deflated with air exhaust.

8. The massage device according to claim 4, wherein
when the bag is a first bag,
the sandwiching portion is a second bag that is inflated with air intake and deflated with air exhaust.

9. The massage device according to claim 1, wherein
the base sheet includes a support hole penetrating the base sheet in the thickness direction,
the air bag includes a joint portion that joins the bag and the sandwiching portion, and
in plan view in the thickness direction, the joint portion is smaller than the support hole, and the bag and the sandwiching portion are larger than the support hole.
